(19) United States
(12) Patent Application Publication
(10) Pub. No.: US 2010/0178891 A1
(43) Pub. Date: Jul. 15, 2010

(54) METHOD AND CIRCUIT FOR CALIBRATING ANALOG CIRCUIT COMPONENTS

(75) Inventors: Chun Hsien WEN, Jhubei City (TW); Jiunn Tsair CHEN, Jhubei City (TW); Yen Chin LIAO, Jhubei City (TW); Yung Szu TU, Jhubei City (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, Jhubei City (TW)

(21) Appl. No.: 12/499,587

(22) Filed: Jul. 8, 2009

(30) Foreign Application Priority Data
Jan. 9, 2009 (TW) 098100568

(51) Int. Cl. H04B 17/00

(52) U.S. Cl. 455/226.1

(57) ABSTRACT

A method for calibrating an analog circuit component comprises the steps of: generating a first signal with a baseband frequency; generating a second signal by processing the first signal via the analog component to be calibrated; generating a third signal by processing the second signal via a power amplifier, wherein the power amplifier operates in a nonlinear region; generating a fourth signal by processing the third signal via a low-pass filter; and defining the adjustment for the In-phase-Quadrature-phase imbalance (IQ imbalance) of the analog component and then re-executing the step of generating the first signal, if the fourth signal shows an IQ imbalance mismatch.

### BACKGROUND OF THE INVENTION

1. Field of the Invention

The present invention relates to an application of communication chips, and more particularly, to a calibration method for the In-phase-Quadrature-phase imbalance (IQ imbalance) of communication chips.

2. Description of the Related Art

Typical analog components in communication chips, such as mixers, local oscillators or low-pass filters, are opted to generate gain and phase mismatches in the in-phase and quadrature-phase components of the passing signals. The phenomenon is also known as the IQ imbalance of these analog components.

A conventional calibration method for the IQ imbalance of such analog components is to generate a digital baseband test signal first, to convert the digital baseband test signal into an analog test signal and then to pass the analog signal through these analog components to generate a high frequency analog signal with gain and phase mismatches. Then, the high frequency analog signal is passed through a mixer to generate a down-converted analog signal, the down-converted analog signal is converted into a digital signal and the spectrum of the digital signal is analyzed to determine the IQ imbalance of these analog components.

However, the mixer is on the feedback path of the digital baseband test signal. Therefore, the mixer only operates when the IQ imbalance of these analog components is calibrated, not in the normal mode when the signal is transmitted, and thus the hardware usage percentage of the communication chip is reduced.

Therefore, there is a need to design a method for calibrating IQ imbalance such that the step of passing the signal through a mixer can be eliminated. In this way, not only can the design cost and area of the communication chip be reduced, but the hardware usage efficiency of the communication chip can be increased.

### SUMMARY OF THE INVENTION

One embodiment of the present invention discloses a method for calibrating an analog component. The method uses the nonlinearity effect of a power amplifier to replace the low-pass filter of the prior art and thus reduces the circuit area.

The method for calibrating analog components according to one embodiment of the present invention comprises the steps of: generating a first signal with a baseband frequency; passing the first signal through the analog components to be calibrated to generate a second signal; passing the second signal through a power amplifier to generate a third signal, wherein the power amplifier operates in a nonlinear region; filtering out the high-frequency component of the third signal to generate a fourth signal with a baseband frequency; and adjusting the calibration parameters corresponding to an IQ imbalance if the fourth signal shows such IQ imbalance and re-executing the step of generating a first signal according to the calibration parameters.

The circuit for calibrating analog components according to another embodiment of the present invention comprises a power amplifier, a low-pass filter, an analog-to-digital converter and a spectrum analysis unit. The power amplifier is configured to amplify the output signal of the analog components to be calibrated and operates in a nonlinear region. The low-pass filter is configured to filter the output signal of the power amplifier. The analog-to-digital converter is configured to convert the output signal of the low-pass filter. The spectrum analysis unit is configured to analyze the output signal of the analog-to-digital converter.

The method for calibrating a wireless transceiver according to another embodiment of the present invention comprises the steps of; generating a first signal with a baseband frequency; passing the first signal through the analog components to be calibrated to generate a second signal; passing the second signal through a power amplifier to generate a third signal, wherein the power amplifier operates in a nonlinear region; filtering out the high-frequency component of the third signal to generate a fourth signal with a baseband frequency; and emitting the fourth signal on a carrier frequency, adjusting the calibration parameters corresponding to an IQ imbalance if the fourth signal shows such IQ imbalance and re-executing the step of generating a first signal according to the calibration parameters.

The wireless transceiver according to another embodiment of the present invention comprises a power amplifier, a low-pass filter, an analog-to-digital converter, a spectrum analysis unit and an antenna. The power amplifier is configured to amplify the output signal of the analog components to be calibrated and operates in a nonlinear region. The low-pass filter is configured to filter the output signal of the power amplifier. The analog-to-digital converter is configured to convert the output signal of the low-pass filter. The spectrum analysis unit is configured to analyze the output signal of the analog-to-digital converter. The antenna is configured to emit the output signal of the power amplifier on a carrier frequency.

### BRIEF DESCRIPTION OF THE DRAWINGS

The objectives and advantages of the present invention will become apparent upon reading the following description and upon referring to the accompanying drawings of which:

FIG. 1 shows the flow chart of a method for calibrating IQ imbalance of analog components according to one embodiment of the present invention;

FIG. 2 shows a calibration circuit for calibrating IQ imbalance of analog components according to one embodiment of the present invention;

FIG. 3 shows a frequency response chart according to one embodiment of the present invention;

FIG. 4 shows a gain response chart according to one embodiment of the present invention;

FIG. 5 shows another frequency response chart according to one embodiment of the present invention; and

FIG. 6 shows a calibration circuit for the nonlinear effect of a power amplifier according to one embodiment of the present invention.

### DETAILED DESCRIPTION OF THE INVENTION

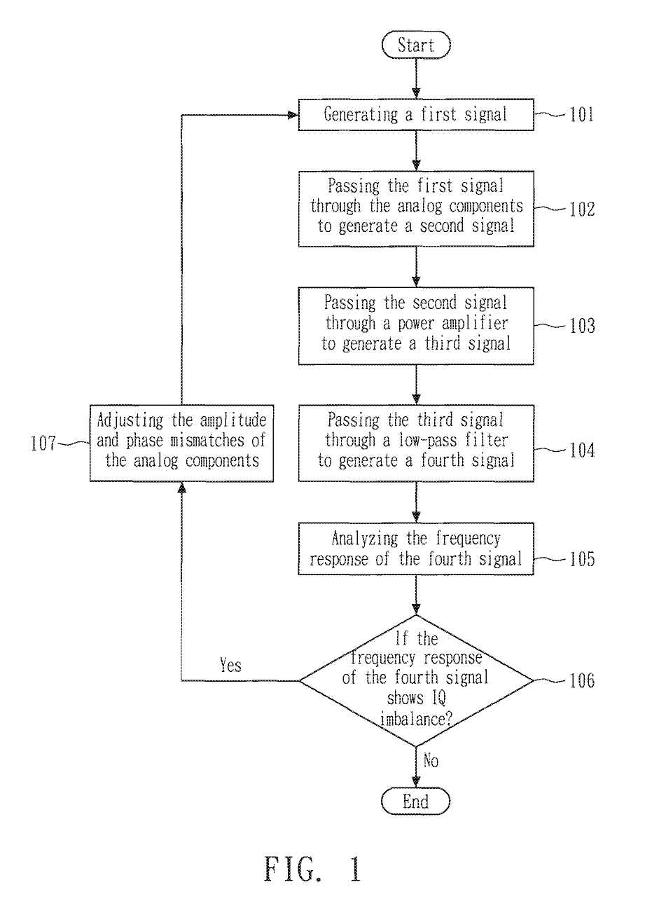

FIG. 1 shows the flow chart of a method for calibrating IQ imbalance of analog components according to one embodiment of the present invention. In step 101, a first signal with a baseband frequency is generated, and step 102 is executed. In step 102, the first signal is passed through the analog components to be calibrated to generate a second signal, and step 103 is executed. In step 103, the second signal is passed through a power amplifier to generate a third signal, wherein the power amplifier operates in a nonlinear region, and step 104 is executed. In step 104, the third signal is passed through a low-pass filter to generate a fourth signal with a baseband frequency, and step 105 is executed. In step 105, the frequency response of the fourth signal is analyzed, and step 106 is executed. In step 106, the frequency response of the fourth signal is checked to determine whether it shows IQ imbalance. If the frequency response of the fourth signal shows IQ imbalance, step 107 is executed; otherwise, the calibration method is ended. In step 107, the gain and phase mismatches of the analog components are adjusted according to the IQ imbalance indicated by the frequency response of the fourth signal, and step 101 is re-executed.

The flow chart of a method for calibrating a wireless transceiver according to one embodiment of the present invention is similar to that shown in FIG. 1, except that in step 107, the fourth signal is emitted on a carrier frequency to achieve the objective of transmitting a wireless signal.

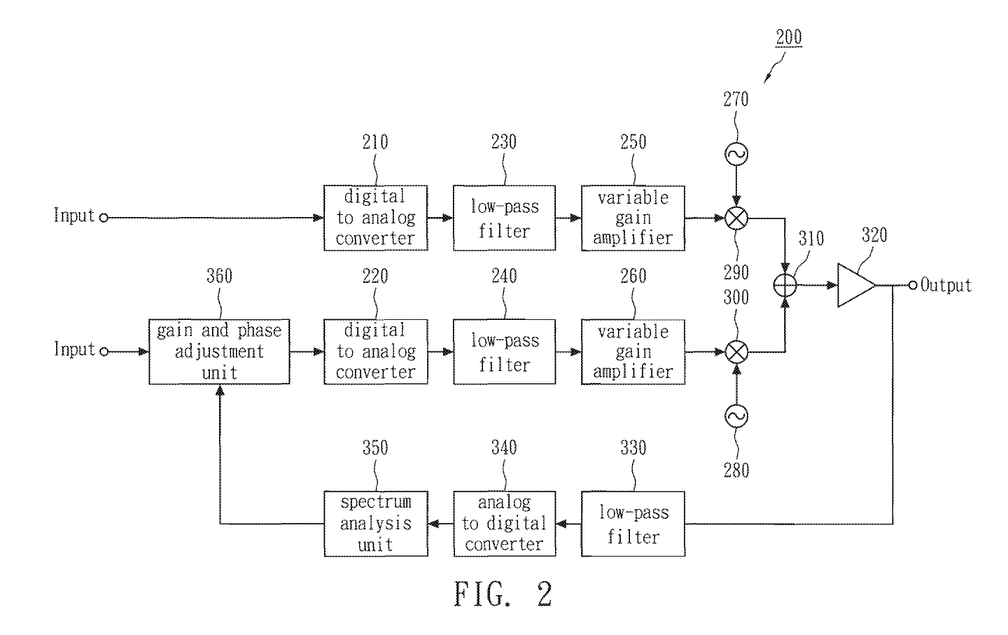

FIG. 2 shows a calibration circuit for calibrating IQ imbalance of analog components according to one embodiment of the present invention. The calibration circuit 200 comprises digital to analog converters 210 and 220, low-pass filters 230 and 240, variable gain amplifiers 250 and 260, local oscillators 270 and 280, mixers 290 and 300, an adder 310, a power amplifier 320, a low-pass filter 330, an analog-to-digital converter 340, a spectrum analysis unit 350 and a gain and phase adjustment unit 360. The digital to analog converters 210, the low-pass filter 230, the variable gain amplifier 250, the local oscillator 270 and the mixer 290 comprise the in-phase signal path of the calibration circuit 200. The digital to analog converters 220, the low-pass filter 240, the variable gain amplifier 260, the local oscillator 280 and the mixer 300 comprise the quadrature-phase signal path of the calibration circuit 200. The low-pass filter 330, the analog-to-digital converter 340, the spectrum analysis unit 350 and the gain and phase adjustment unit 360 comprise the feedback path of the calibration circuit 200.

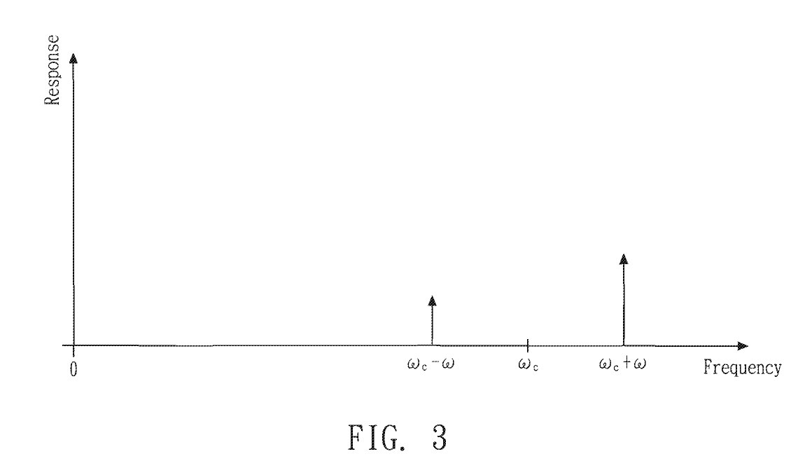

Applying the calibration method shown in FIG. 1 to the calibration circuit shown in FIG. 2, a first signal with a baseband frequency is generated and passes the in-phase signal path and the quadrature-phase signal path of the calibration circuit 200. The adder 310 then accumulates the output signals of the two paths to generate the second signal. In the present embodiment, if the first signal is a sine wave signal, the second signal can be represented as Re{[cos ωt+jg sin(ωt+θ)]e^{jω}_{ᵣ}^{t}}, wherein Re represents the real part signal in the parentheses, g and θ respectively represent the gain and phase mismatches generated by the analog components on the two paths, and ω_{c} represents the central frequency of the second signal. If there are no gain and phase mismatches in the second signal, i.e. if there is no IQ imbalance between the in-phase and the quadrature-phase paths, then the gain g equals 1 and the phase θ equal 0. The second signal can be re-represented as

$$Re \{ [ \begin{matrix}( \frac{1 + g {e}^{j θ}}{2} ) {e}^{j ω t} + \\ ( \frac{1 - g {e}^{- j θ}}{2} ) {e}^{- j ω t}\end{matrix} ] {e}^{j {ω}_{r} t} \} = Re \{ [ {K}_{1} {e}^{jω t} + {K}_{2} {e}^{- j ω t} ] {e}^{{jω}_{r} t} \} ,$$

wherein the frequency response is shown in FIG. 3, the signal at frequency ω_{c}+ω is the original signal, and the signal at frequency ω_{c}−ω is the signal generated by the gain and phase mismatches of the analog components.

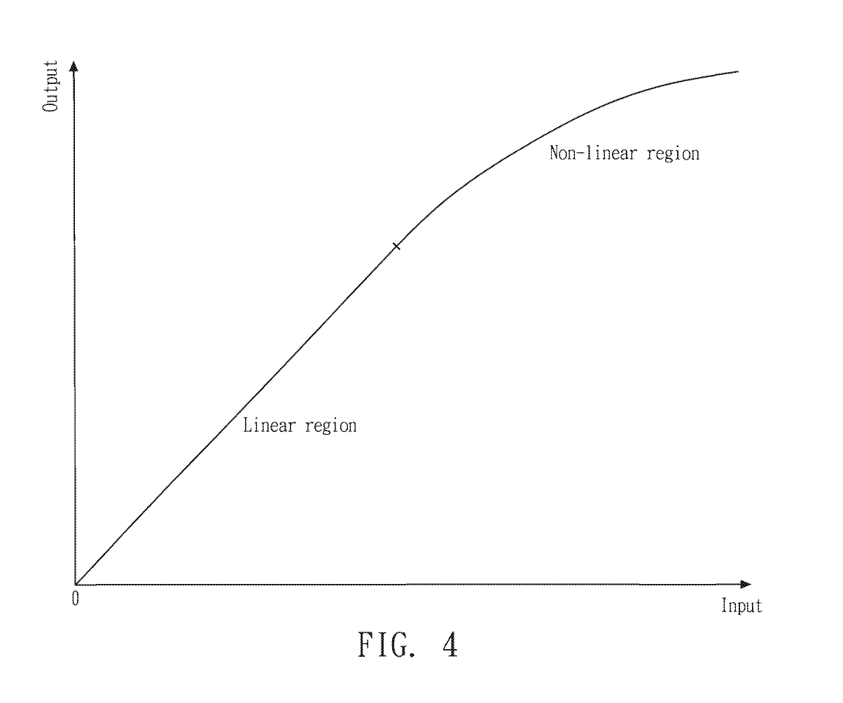

Referring back to FIG. 2, the present embodiment utilizes the nonlinear characteristic of the power amplifier 320 to let the second signal pass through and then generate the third signal. FIG. 4 shows the gain response of the power amplifier 320. As shown in FIG. 4, the gain response of the power amplifier 320 is divided into a linear region and a nonlinear region. When signals are transmitted normally, the power amplifier 320 operates under the linear region. When the IQ imbalance of the analog components is calibrated, the power amplifier 320 operates under the nonlinear region. The characteristics of the nonlinear region can be represented by the polynomial as follows: y=a+bx+cx²+dx³+ . . . , wherein x is the input and y is the output. The first order gain keeps the components of the second signal in the third signal. The higher order gains enable the power amplifier 320 to act as a mixer such that the third signal comprises the down-converted components of the second signal.

The third signal then passes through the low-pass filter 330, which can be realized by an envelope detector, to reserve the low-frequency components of the third signal, i.e. the fourth signal. The fourth signal is then converted by the analog-to-digital converter 340 to analyze the gain and phase mismatches, i.e. the value of g and θ, by the spectrum analysis unit 350. If g is not equal to 1 and θ does not equal 0, then the gain and phase adjustment unit 360 stores the calibration results to adjust the amplitude and phase of the input signal to the quadrature-phase path.

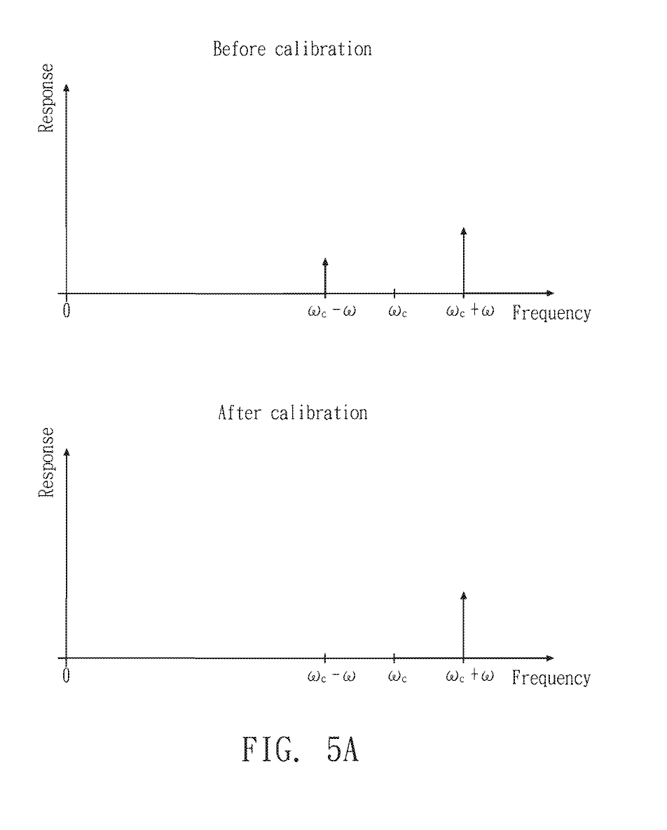

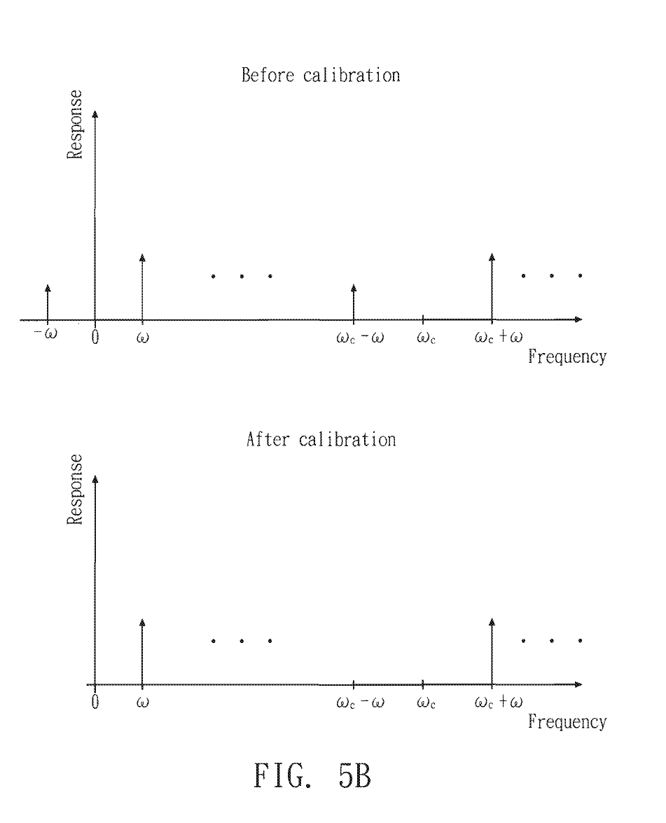

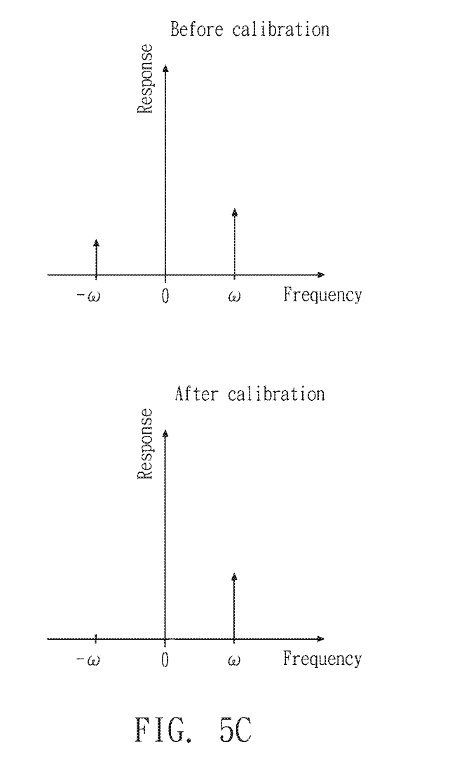

FIG. 5 shows the frequency responses of each point in the calibration circuit 200 before and after calibration. FIG. SA shows the frequency response of the second signal. As shown in FIG. 5A, the second signal before calibration has a component generated due to the IQ imbalance of the analog components. FIG. 5B shows the frequency response of the third signal. As shown in FIG. 5B, the third signal has duplicate components of the second signal at several frequencies. FIG. 5C shows the frequency response of the fourth signal.

The wireless transceiver apparatus according to one embodiment of the present invention is similar to the circuit shown in FIG. 2, except that it further comprises an antenna to emit the output signal of the power amplifier 320 on a carrier frequency.

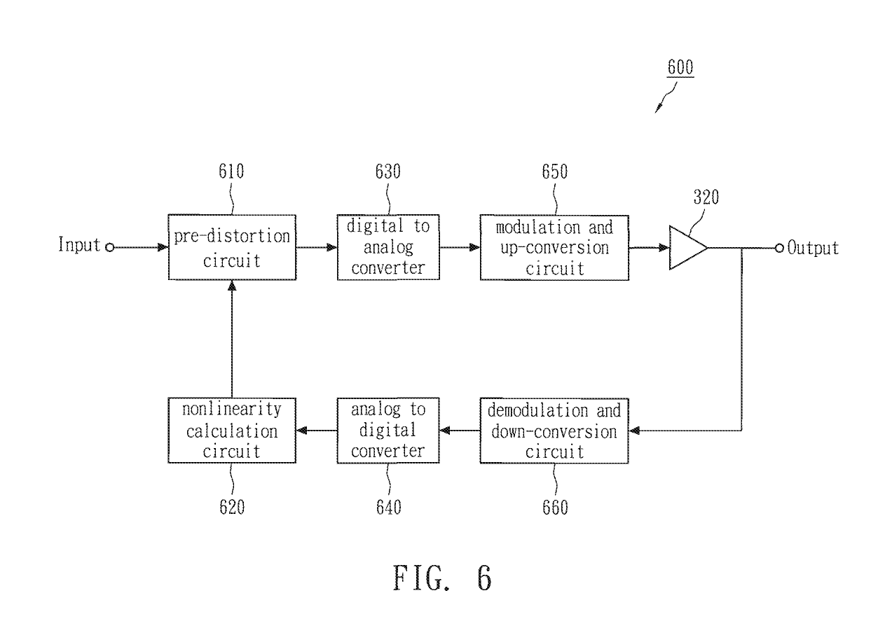

Preferably, a calibration of the nonlinear effect of the power amplifier 320 can be realized after the calibration for the IQ imbalance of the analog components is complete. FIG. 6 shows a calibration circuit for the nonlinear effect of the power amplifier 320. The calibration circuit 600 comprises a pre-distortion circuit 610, a calibration calculation circuit 620, a digital to analog converter 630, an analog-to-digital converter 640, a modulation and up-conversion circuit 650, a demodulation and down-conversion circuit 660 and the power amplifier 320. The digital to analog converter 630 and the up-conversion circuit 650 can be realized by the in-phase and the quadrature-phase paths of the calibration circuit 200. The analog-to-digital converter 640 can be realized by the analog-to-digital converter 340. The demodulation and down-conversion circuit 660 can be realized by the low-pass filter 330.

After the calibration for the IQ imbalance of the analog components is complete, the input signal of the digital to analog converter 630 and the output signal of the analog-to-digital converter 640 are compared, i.e. the first signal and the fourth signal are compared in the calibration calculation circuit 620 to update the parameters of the pre-distortion circuit 610 such that the nonlinearity effect of the power amplifier 320 is compensated. Preferably, the calibration calculation circuit 620 can utilize a least mean square (LMS) algorithm, and the pre-distortion circuit 610 can be realized by a look-up table.

In conclusion, the calibration method for the IQ imbalance of the analog components of the present embodiment utilizes the nonlinearity effect of a pre-existing power amplifier and thus an additional mixer is not necessary, and the area and cost of the circuit is reduced. In addition, the present embodiment calibrates the nonlinearity effect of the power amplifier by the calibrated analog components of the circuit to improve the calibration accuracy.

The above-described embodiments of the present invention are intended to be illustrative only. Those skilled in the art may devise numerous alternative embodiments without departing from the scope of the following claims.

What is claimed is:

1. A method for calibrating an analog component, comprising the steps of:
generating a first signal with a baseband frequency;
passing the first signal through the analog component to be calibrated to generate a second signal;
passing the second signal through a power amplifier to generate a third signal, wherein the power amplifier operates in a nonlinear region;
filtering out a high-frequency component of the third signal to generate a fourth signal with a baseband frequency; and
adjusting calibration parameters corresponding to an In-phase-Quadrature-phase imbalance (IQ imbalance) if the fourth signal shows the IQ imbalance, and re-executing the step of generating a first signal according to the calibration parameters.

2. The method of claim 1, wherein the first signal is a sine wave signal.

3. The method of claim 1, wherein the analog component to be calibrated comprises a low-pass filter, a variable gain amplifier and a mixer.

4. The method of claim 1, wherein the step of filtering the third signal is realized by an envelope detector.

5. The method of claim 1, wherein the calibration parameters corresponding to the IQ imbalance comprises a gain calibration parameter and a phase calibration parameter.

6. The method of claim 1, further comprising the steps of:
generating a calibration parameter for a nonlinearity of the power amplifier according to the first signal and the fourth signal if the fourth signal does not show the IQ imbalance.

7. The method of claim 6, wherein the step of generating a calibration parameter for the nonlinearity of the power amplifier is calculated by a least mean square algorithm.

8. The method of claim 6, wherein the step of generating a calibration parameter for the nonlinearity of the power amplifier is realized by a look-up table.

9. A circuit for calibrating an analog component, comprising:
a power amplifier operating in a nonlinear region and configured to amplify an output signal of the analog component to be calibrated;
a low-pass filter configured to filter an output signal of the power amplifier;
an analog-to-digital converter configured to convert an output signal of the low-pass filter; and
a spectrum analysis unit configured to analyze an output signal of the analog-to-digital converter.

10. The circuit of claim 9, wherein the analog component to be calibrated comprises a low-pass filter, a variable gain amplifier and a mixer.

11. The circuit of claim 9, further comprising:
a pre-distortion circuit configured to adjust an input signal to compensate a nonlinearity effect of the power amplifier; and
a calibration calculation circuit configured to adjust compensation parameters of the pre-distortion circuit according to the output signal of the power amplifier.

12. The circuit of claim 11, wherein the calibration calculation circuit utilizes a least mean square algorithm.

13. The circuit of claim 11, wherein the pre-distortion circuit is realized by a look-up table.

14. A method for calibrating a wireless transceiver, comprising the steps of:
generating a first signal with a baseband frequency;
passing the first signal through analog component to be calibrated to generate a second signal;
passing the second signal through a power amplifier to generate a third signal, wherein the power amplifier operates in a nonlinear region;
filtering out a high-frequency component of the third signal to generate a fourth signal with a baseband frequency; and
emitting the fourth signal on a carrier frequency, adjusting calibration parameters corresponding to an In-phase-Quadrature-phase imbalance (IQ imbalance) if the fourth signal shows the IQ imbalance, and re-executing the step of generating a first signal according to the calibration parameters.

15. The method of claim 14, wherein the first signal is a sine wave signal.

16. The method of claim 14, wherein the analog component to be calibrated comprises a low-pass filter, a variable gain amplifier and a mixer.

17. The method of claim 14, wherein the calibration parameters corresponding to the IQ imbalance comprise a gain calibration parameter and a phase calibration parameter.

18. A wireless transceiver, comprising:
a power amplifier operating in a nonlinear region configured to amplify an output signal of analog component to be calibrated;
a low-pass filter configured to filter an output signal of the power amplifier;
an analog-to-digital converter configured to convert an output signal of the low-pass filter;
a spectrum analysis unit configured to analyze an output signal of the analog-to-digital converter; and
an antenna configured to emit an output signal of the power amplifier on a carrier frequency.

19. The wireless transceiver of claim 18, wherein the analog component to be calibrated comprises a low-pass filter, a variable gain amplifier and a mixer.
